(19) United States
(12) Patent Application Publication
(10) Pub. No.: US 2014/0203156 A1
(43) Pub. Date: Jul. 24, 2014

(54) APPARATUS AND METHOD OF MANUFACTURE OF STAND FOR SUPPORTING AN ELECTRONIC DEVICE

(71) Applicant: WILD WEST INVESTMENTS, LLC, Dallas, TX (US)

(72) Inventor: Gavin Stener, Dallas, TX (US)

(73) Assignee: WILD WEST INVESTMENTS, LLC, Dallas, TX (US)

(21) Appl. No.: 14/161,222

(22) Filed: Jan. 22, 2014

Related U.S. Application Data
(60) Provisional application No. 61/755,366, filed on Jan. 22, 2013.

(51) Int. Cl. F16M 11/12; F16M 11/18; F16M 13/02

(52) U.S. Cl. CPC F16M 11/12; F16M 13/022; F16M 11/18
USPC 248/425; 248/188.1; 248/178.1; 29/428

(57) ABSTRACT

A stand for supporting and retaining a personal electronic device may include a base and a unified frame having a curved shape between a first end and a second end. The first end of the unified frame may be coupled to the base. A support member may be coupled to the second end of the unified frame, and be configured to support and retain the personal electronic device.

### CROSS REFERENCE TO RELATED APPLICATION

This Application claims the benefit, under 35 U.S.C. §119(e), of the filing of U.S. Provisional Patent Application Ser. No. 61/755,366 entitled “Apparatus And Method Of Manufacture Of A Stand For Supporting And Retaining A Personal Electronic Device,” filed Jan. 22, 2013, which is in its entirety incorporated herein by reference for all purposes.

### BACKGROUND

Use of personal electronic devices (PEDs), such as laptop computers, smartphones, tablet computers or tablets, portable gaming devices, and the like, has become pervasive in society. In recent years, interacting with personal electronic devices has started to become as or more desirable to people, both young and old, than watching television while at home and other places. Despite weight of the personal electronic devices being relatively light as compared to previous generations of similar devices, users are limited in using the devices as a result of their hands having to both be used while operating the devices (i.e., one hand to hold, one hand to operate, and/or both hands to operate). Thus, it would be desirable to enable a user to utilize a personal electronic device without restricting hand usage as described above and provide a better working or leisure environment, whether the user be sitting in a chair, standing, or in bed.

### SUMMARY

A stand that provides a user of a personal electronic device with less restrictive hand usage is provided. The stand may be configured to support and retain the personal electronic device. The personal electronic device may be temporarily supported and retained by the stand at a height that is fixed or adjustable. By retaining the personal electronic device, the personal electronic device can be prevented from falling from the stand if accidentally bumped or moved, but be capable of being released with minimal effort.

One embodiment of a stand for supporting and retaining a personal electronic device may include a base and multiple frames, such as a pair, three, or more. Each of the frames may have a curved shape, such as a shape defined by a spline. Multiple spacers being substantially equal in length may be disposed between the pair of frames, thereby causing the frames to be substantially parallel with one another so as to form a unified frame member. An adapter member may be configured to couple one end of the unified frame member with the base. A support member may be configured to be supported by the unified frame at an opposite end from the base, and support and retain the personal electronic device.

One embodiment of a method of manufacture of a stand for supporting and retaining a personal electronic device may include providing a unified frame having a curved shape between a first end and a second end. A base may be provided, and the unified frame may be coupled to the base. A support member may be supported at the second end of the unified frame, where the support member may be adapted to support and retain the personal electronic device.

Another embodiment of a stand for supporting and retaining a personal electronic device may include a base and a unified frame having a curved shape between a first end and a second end. The first end of the unified frame may be coupled to the base. A support member may be coupled to the second end of the unified frame, and be configured to support and retain the personal electronic device.

### BRIEF DESCRIPTION

The accompanying drawings, which are incorporated in and constitute a part of this specification, illustrate an implementation of the present invention and, together with the description, serve to explain the advantages and principles of the invention. In the drawings:

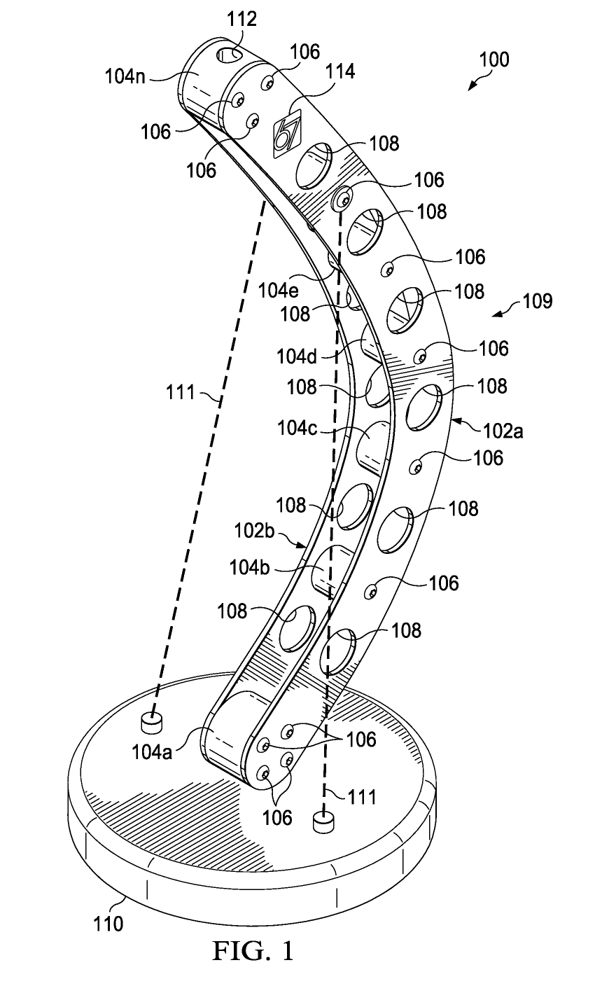

FIG. 1 is an illustration of an illustrative stand that may be used as a support structure for supporting and retaining a personal electronic device;

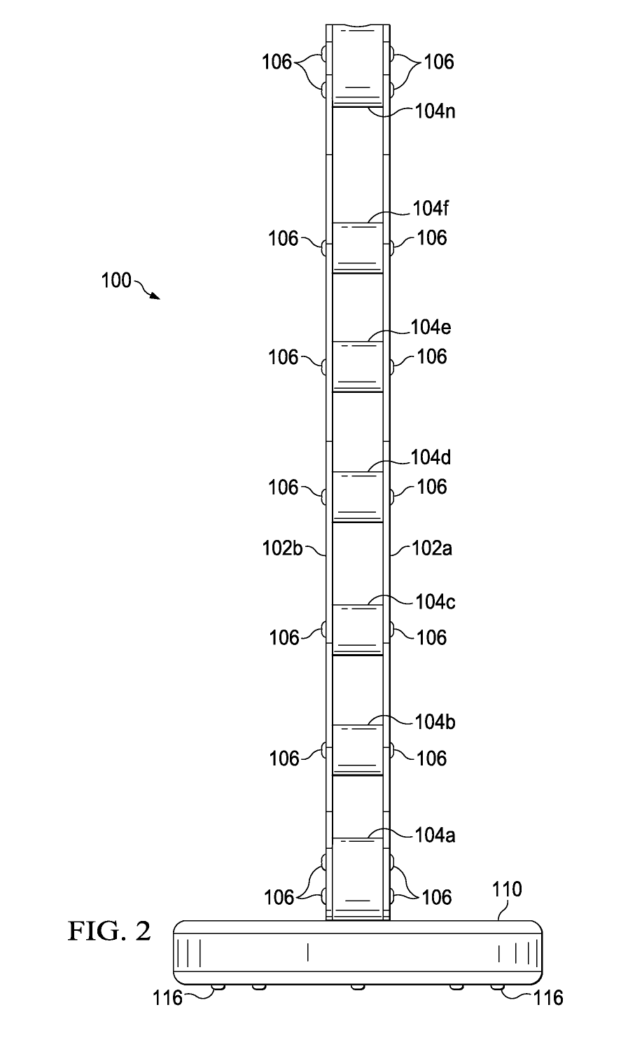

FIG. 2 is an illustration of a front view of the stand of FIG. 1;

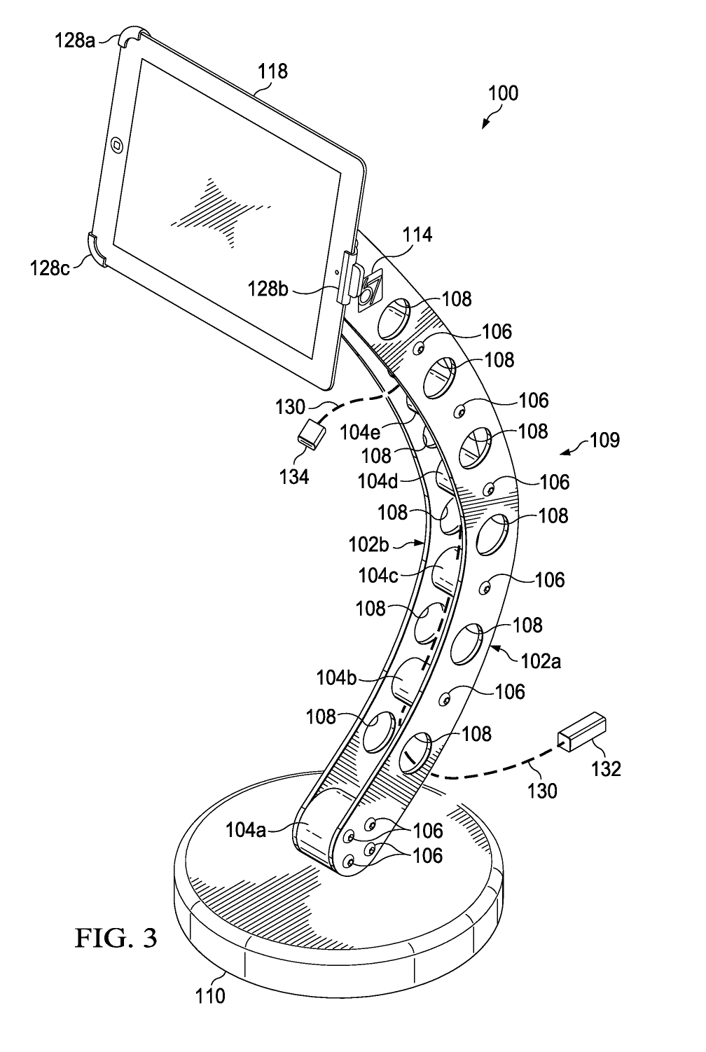

FIG. 3 is an illustration of a front isometric view of the stand of FIG. 1;

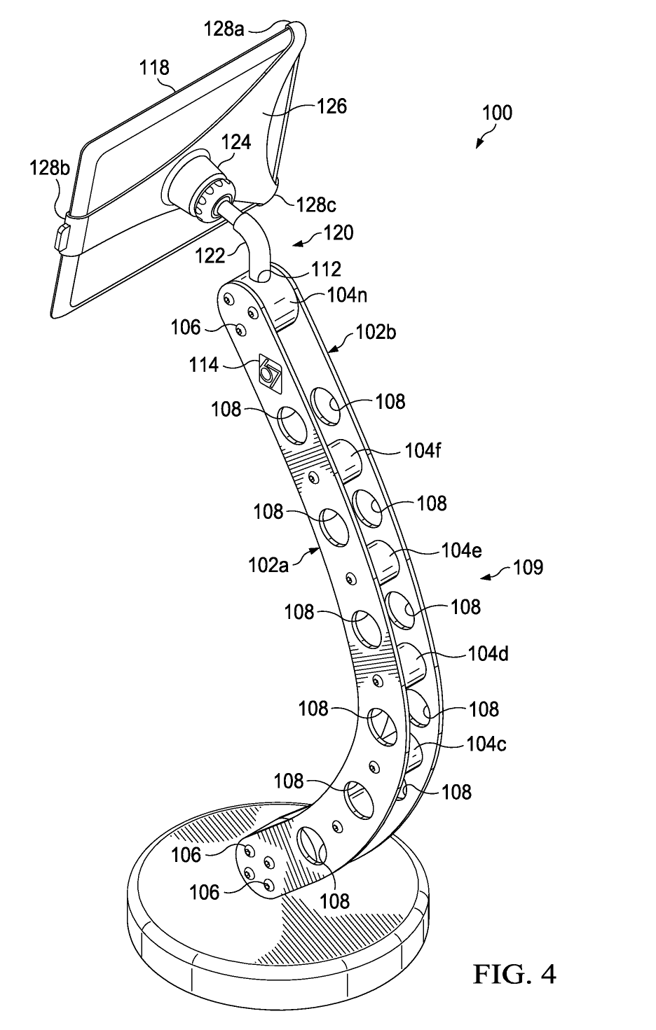

FIG. 4 is an illustration of a rear isometric view of the stand of FIG. 1; and

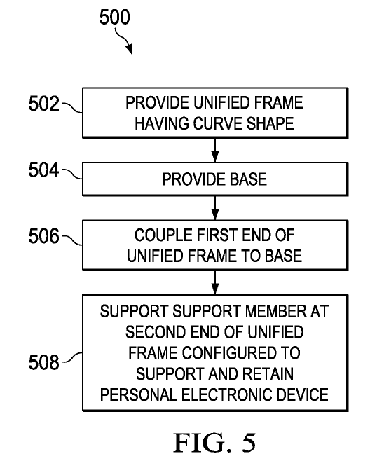

FIG. 5 is a flow diagram of a process for manufacturing a stand for supporting and retaining a personal electronic device in accordance with the principles of the present invention.

### DETAILED DESCRIPTION

FIG. 1 is an illustration of an illustrative stand 100 that may be used as a support structure for supporting and retaining a personal electronic device (see FIGS. 3 and 4). The stand 100 may include frames 102a and 102b (collectively 102) that are formed of a stiff material. The material may be metal, wood, fiberglass, thermoplastic, or any other material with sufficient strength to support a personal electronic device and to resist bending or breaking if accidentally struck. The stiffness of the material may also be high enough to avoid being too compliant when a user is operating his or her personal electronic device, thereby minimizing shaking or wobbling of the stand 100, when being supported and retained by the stand 100. Although not shown in FIG. 1, it should be understood that the stand 100 includes a support mechanism that functions to support and retain a personal electronic device, as further described herein.

The stand 100 may include a plurality of spacers 104a-104n (collectively 104) that are disposed between the frames 102. The spacers 104 may be approximately the same axial length, such that the frames 102 are substantially parallel with one another. Alternative, non-parallel frames and non-approximately equal length spacer configurations may be utilized in accordance with the principles of the present invention. The spacers 104 may be circular, as shown. Alternative geometric shapes, such as squares, rectangles, triangles, and ovals, or non-geometric shapes may be utilized. It should be understood that non-identically shaped spacers may be utilized. While the spacers 104 provide certain structural integrity to the stand 100, the spacers 114 also provide a distinctive ornamental characteristic to the stand 100.

The spacers 104 may have the approximate same shape, but the spacers 104a and 104n may be sized different from spacers 104b-104e (i.e., non-end spacers), as spacers 104a and 104n may be adapted to support the frames 102 on a bottom end and a personal electronic device (not shown) on a top end of the frames 102. The spacers 104 may also be made of any stiff material, such as metal, wood, thermoplastic, and so on, to provide strength and stability.

In one embodiment, fastening members 106 may be utilized to fixedly secure the spacers between the frames 102. To enable the fastening members to extend through the frames 102 and spacers 104, the frames 102 may define openings and the spacers 104 may define openings that enable the fastening members 106 to fixedly secure the spacers 104 between the frames 102. The fastening members 106 may be bolts, screws, pins, or any other fastening member, as understood in the art. In one embodiment, the fastening members 106 may have heads that are conventional and/or ornamental in nature. The opening defined by the frames 102 and/or spacers 104 may be threaded or be sized to enable threaded fastening members 106 to pass therethrough without obstruction. The openings defined by the spacers 106 may extend through the entire spacers or partially therethrough, such that one or two (i.e., one from each side) fastening members may be utilized per spacer. It should be understood that multiple fastening members 106, such as two or more, may be utilized for each side of a spacer (e.g., spacer 104a having four fastening members 106 and spacer 104n having three fastening members 106). Shapes and sizes of the spacers 104 may dictate how many and in what positions fastening members 106 may be utilized for each spacer.

While the spacers 104 shown in FIG. 1 are shown to be in a series, it should be understood that alternative configurations are possible. For example, parallel spacers (i.e., spacers positioned side-by-side) or clusters of spacers are possible. In an alternative configuration, rather than utilizing independent spacers, one or more integrated spacers may be used, where the integrated spacer and frames may be manufactured as a single unit. Alternatively, spacer(s) may be welded, fused, or otherwise joined together, such that the frames and spacer(s) are inseparable. In one embodiment, rather than using fastening members 106, the frames may define pockets (not shown) on center sides, such that the spacers 104 may be adhesively connected or bonded within the pockets, thereby allowing for simplified assembly. The adhesive connections may utilize glue, epoxy, or other fastening means known in the art.

The frames 102 may further define openings 108 that extend along the frames 102. The openings 108 may be utilized to reduce weight from the frames 102, but also provide a distinctive ornamental appearance to the overall stand 100. As shown, the openings 108 are circular. It should be understood, however, that the openings 108 may be any geometric or non-geometric shape. The openings 108 may be separated by sufficient portions of the frames 102 to maintain strength to avoid bending or other deformation due to weight of the personal electronic device being supported or as a result of accidental contact by a person or object. It should be understood that the use of openings 108 is optional.

The combination of the frames 102, spacers 104, and fastening members 106, if used, defines a unified frame 109. The unified frame 109 may include independent and/or integrated spacer(s) 104 and multiple frames 102 (two or more). Additional features may also be included as part of the unified frame 109. The unified frame 109 may be assembled and mounted to a base 110. The base 110 may have a circular shape, be sufficiently wide, and be heavy enough to resist tipping over in the event of accidental contact of the stand 100 by a person or object. Alternative shapes may be utilized. The stand 100 may include a single frame component that incorporates one or more other features of the stand described herein. Such a single frame configuration would not be considered a unified frame. In one embodiment, the base may be solid aluminum, hollow aluminum with sand or other material used to fill the base, or any other material or combination of materials.

The base 110 may have a weight and width or diameter that, in combination with the shape of the unified frame 109, causes a center of gravity (COG), as understood in the art, to be positioned over the base 110. The more the center of gravity is centrally positioned over the base 110, the more stable the stand 100 is and less likely to be knocked over in the event of contact by an object or person. For larger stands, stays 111 (shown as dashed lines due being optional components), such as those used to maintain masts of sailboats, may be mounted between the base 110 and the unified frame 109 to provide additional lateral stability to the stand 100. In one embodiment, the stays 111 may be fixedly attached to the base 110 and secured to a fastening member near the top of the unified frame.

To achieve the balance, the unified stand 109 may have a spline shape (i.e., a curve defined by at least three points) that counter-balances a personal electronic device and/or additional attachments or objects that may be supported by the stand 100. Splines may be calculated utilizing a number of different algorithms, such as a cubic or “natural” curve, as understood in the art. Of course, supporting hardware, such as a bracket and associated mount, used to support the personal electronic device, may be factored into the counter-balance. Because the weight of the personal electronic device counter-balances the unified frame 109, the center of gravity is positioned off-center from the base 110 without a personal electronic device being supported by the stand 100, such that when the personal electronic device is supported by the stand 100, the center of gravity shifts toward or over the center of the base 110.

The base 110 may alternatively be configured with a rechargeable battery or uninterruptible power supply (not shown), as understood in the art. The rechargeable battery may be electrically coupled to a circuit that is configured to recharge the rechargeable battery, as understood in the art. In one embodiment, the base 110 may include wireless circuitry, such as an RF transceiver, that is capable of transmitting and receiving wireless signals via a router, remote control, Wi-Fi® enabled device, etc., may be included to wirelessly control operation of a personal electronic device positioned on the stand 100 or electromechanical devices configured on the stand 100, as further described hereinbelow.

The base 110 may be further or alternatively be configured with a theft prevention and/or tracking device to create an audible signal, visual signal, and/or wireless signal, for example, to alert someone that the stand is being and/or has been moved from a position. The theft prevention device may include a tilt sensor or motion sensor to identify that the stand has been tilted or moved. In one embodiment, the sensor may include an RFID device (not shown) that, in conjunction with a system, may identify that the stand is being moved from a store or house, for example, and generate an audible, visual, and/or silent alarm. The silent alarm may include communication of a text message, for example, inclusive of a geographic position (e.g., GPS signal) of the stand via a mobile communications system utilizing a GPS or other geographic positioning circuit and communication circuit, as understood in the art. In the case of having an audible alarm, an alarm circuit and speaker may be included in the base. Still yet, because the stand is intended for use with a personal electronic device, quality speaker and/or projector systems (not shown) may be integrated into the base and/or unified frame such that a user may elect to play music and/or content, such as a slideshow or movie, while using the personal electronic device, which may store music and/or content, on the stand 100.

In addition to personal use of the stand 100, the stand 100 may be utilized for commercial purposes, such as being positioned in a retail store to provide interactive assistance to shoppers. To prevent the stand from being stolen, the base 110 may define openings or have an adapter such as a metal mesh or straps that define openings to enable bolts to secure the stand 100 to the floor or otherwise.

The spacer 104a positioned closest to the base 110 may be configured with an opening (not shown) that extends at least partially through the spacer 104a. The base 110 may include a protrusion member (not shown) that extends perpendicularly from the base 110 to extend through the opening in the spacer 104a. The protrusion member may have a non-circular profile (e.g., square, oval, hexagonal, etc.) to prevent the unified frame 109 from rotating relative to the base 110. Alternatively, the protrusion member may have a circular profile to enable the unified frame 109 to rotate relative to the base 110. To prevent the unified frame 109 from separating from the base 110, a cotter pin (not shown) may extend through the protrusion member or any other mechanism that performs the function of preventing the protrusion member from disengaging or being separated from the spacer 104a may be utilized. Rather than using a protrusion member, an adapter (not shown) may be mounted to the base and have protrusion members that extend perpendicularly upwards from the base and to the sides of the frames 102a 102b, such that the fastening members 106 can extend through the protrusion members, frames 102, and spacer 104a. The spacers 104a and 104n are shown to be larger than spacers 104b-104e, as spacer 104a supports the unified frame 109 and has multiple fastening members 106, in this case four, to prevent rotation of the unified frame 109 with respect to the base 110, while spacer 104n is configured to support a personal electronic device. The spacer 104n is sized to define an opening 112 to enable a protrusion from a support member (not shown) to extend therein, and enable multiple fastening members 106 to secure the spacer 104n between the frames 102 to prevent rotation of the spacer 104n. One or more cable or wire managers (not shown) that accommodates movement of a power cord and/or data cable, such as a USB cable, for intake within the base, movement of the base, when the personal electronic device is rotated, or other times when a cord and/or cable may be moved.

A logo 114 that may operate as trademark for a manufacturer of the stand 100 may be disposed on one or both frames 102 near the top of the unified frame 109 when mounted to the base 110 or elsewhere on the frame(s) 102. The logo 114 may be formed by a sticker, paint, decal, embossing, engraving, stamping, printing, or otherwise, as understood in the art.

With regard to FIG. 2, a front view of the stand 100 of FIG. 1 is shown. Feet 116 may be coupled to the base 110, and be used to support the stand 100. The feet 116 may be made of a material with a high coefficient of friction, such as rubber, to resist movement. Alternatively, a material with a lower coefficient of resistance, such as plastic or wood, may be utilized for the feet 116. A uniform spacing of feet 116 may be utilized to minimize wobbling of the stand 100. In an alternative embodiment, wheels, casters, or roller balls may be integrated into the base to enable easy movement of the stand 100.

The fastening members 106 may have heads that extend to the side of the frames 102. Alternatively, the fastening members may have heads that are flush or recessed within the frames 102 to have a different ornamental appearance. Alternative configurations, such as caps or covers (not shown) may be coupled between the head of the fastening members 106 and frames 102 or may be mounted to the heads of the fastening members 106. As shown, each of the spacers 104b-104f has one fastening member or a pair of fastening members that are centrally positioned with respect to respective spacers 109b-104f. It should be understood that multiple fastening members 106 may be used for each of the spacers 104b-104f.

With regard to FIGS. 3 and 4, illustrations of front and rear isometric views of the illustrative stand 100 are respectively shown. An illustrative personal electronic device 118 is shown to be supported and retained by a support member 120 that itself is supported by the spacer 104n positioned at the top of the unified frame 109. The personal electronic device 118 in this embodiment is a tablet electronic device. The support member 120 may include a stem 122 configured to extend into the opening 112 of the spacer 104n. In this embodiment, the opening 112 and stem 122 have circular profiles to enable the stem 122 to rotate with respect to the spacer 104n, thereby allowing a user to rotate the personal electronic device 118. The stem 122 may be stiff (e.g., hard plastic) or compliant (rubber). In one embodiment, the stem 122 may be formed of one or more materials or mechanisms that are repositionable and have “memory,” such that the stem 122 can be moved or adjusted and remain in a set position for the user.

The support member 120 may further include a positioning member or adapter member 124 that is rotatable with respect to the stem 122 to enable a user to rotate the device 118, as the device 118 is generally operable to enable a user to rotate an image being displayed thereon. The adapter member 124 may be configured to have multiple, predefined positions (e.g., horizontal and vertical), free rotation that can retain the device 118 in a position as set by the user, or a combination thereof. A locking member (not shown) may also be utilized to lock the adapter member 124 in a set position. One embodiment may include teeth (not shown) that may be separated to allow rotation and integrated to be locked. Any other brake or lock mechanism (not shown) may be utilized to enable a user to position and reposition the device 118 in desired azimuth angles and elevation orientations relative to the spacer 104n. The support member 120 may also include a bracket 126 with retention members 128. The retention members 128a, 128b, and 128c (collectively 128) may be adapted to support and retain, temporarily or more fixedly, the electronic device against the bracket 126. It should be understood that a wide variety of bracket and retainer mechanisms may be utilized in accordance with the principles of the present invention. As an example, while three retention members 128 are shown, a bracket with a nearly solid rim that operates as a retention member may be used. Alternatively, four retention members, one for each corner of the device, with elastic bands or clips to retain the corners of the electronic device to the bracket may be used. Stands meant for personal use may be configured with support members that temporarily retain the personal electronic device, which means that the user can easily retain and release the device 118 (e.g., without having to a device, such as a screwdriver, to support and retain the device 118 on the stand 100). One embodiment of a commercial stand may include a bracket and retention member that locks the device 118 to the support member 120 by use of lock mechanisms (not shown) and/or fastening members (not shown) to prevent theft of the electronic device. Additionally, the support member 120 may include a shelf that may be horizontally aligned to allow for a portable computer or other personal electronic device to be rested thereon. As with other configurations, retainer member(s) may be secured or applied to the shelf to reduce risk of the personal electronic device from falling.

As further shown in FIG. 3, a power cord and/or data cable 130 (shown as a dashed line due to being optional) may extend radially through each of the spacers 104. In one embodiment, the cable 130 may pass through the base 110. Alternatively, the cable 130 may simply exit from the lowest spacer. In one embodiment, a data and/or power connector 132, such as a USB connector, may be included on the end of the cable 130. Alternatively and/or additionally, a plug (not shown) for use in connecting to a wall socket may be located at the end of the cable 130. On the other end of the cable 130, a data and/or power connector 134 that is capable of providing data and/or power to the personal electronic device 118 may be provided. It should be understood that more than one cable may be provided in accordance with the principles of the present invention.

Because the stand 100 is meant to provide freedom to a user of an electronic device, additional attachments (not shown), such as extension arm with lights, arm with stands for books or periodicals, may be attached to the unified frame 109. The attachments may use clamps or be configured to lock or secure into the openings 108, for example. Of course, because the attachments and objects to be supported to the attachments have weight, such weight should be offset by the shape and weight of the unified frame 109 and, optionally, base.

FIG. 5 is a flow diagram of a process 500 for manufacturing a stand for supporting and retaining a personal electronic device in accordance with the principles of the present invention. The process 500 may start at step 502, where a unified frame having a curved shape is provided. A base may be provided at step 504. At step 506, a first end of the unified frame may be coupled to the base. In one embodiment, coupling may include securing the unified frame to the base. Alternatively, coupling may include mounting the unified frame to the base without securing the two together (i.e., the unified frame may be lifted from the base without having to remove or otherwise alter any mechanisms, such as placing an adapter onto a peg or other vertical member extending from the base). At step 508, a support member may be supported at a second end of the unified frame, and be configured to support and retain a personal electronic device. In supporting the support member, the support member may be connected or coupled to the unified frame. In one embodiment, in coupling the support member to the unified frame, the support member may include a spacer defining an opening and enable a stem or other member to be inserted into the opening of the spacer. The support member may also include a positioning member and bracket with retention members, either integrated or non-integrated with the bracket, that enable the personal electronic device to be supported and maintained with the stand. The bracket may enable temporary retention or more permanent retention if theft is of concern, such as being utilized at a retail store.

In one embodiment, the stand 100 may be automated to a certain extent. For example, the stand 100 may have a “home” station, where the home station is a physical location that is defined by a device, such as a charging station, or a location storable in a memory of a robotic system, such as one that is integrated or separately configurable to a base. The user may program the robot being used to control location of the stand 100 to know the location of the “home” station or the robot may follow a signal being communicated from the home station. In one embodiment, arm(s) may be controlled by servo(s) and motor(s) that control position of the arm(s) to cause the arm(s) to move up, down, left, or right. A stand with such a motion may include rotation mechanisms, including hinge(s), strut(s), or any other types of rotation supporting mechanisms, as understood in the art. Control of the servo(s) and motor(s) may be controlled by control element(s), such as buttons, switches, knobs, remote control, or otherwise, positioned on the stand 100. Alternatively, an app being executed by a personal electronic device, may cause signal(s) to be communicated to a robot operating on the stand 100 to reposition or otherwise cause the stand to move or be controlled (e.g., turn on light). Still yet, the robot may be audible (e.g., voice, clap, etc.) operated.

The previous description is of a preferred embodiment for implementing the invention, and the scope of the invention should not necessarily be limited by this description. The scope of the present invention is instead defined by the following claims.

What is claimed:

1. A stand for supporting and retaining a personal electronic device, said stand comprising:
a base;
a plurality of frames each having a shape defined by a spline;
a plurality of spacers being substantially equal in length, said spacers, when disposed between said plurality of frames, causing said frames to be substantially parallel with one another so as to form a unified frame member;
an adapter member configured to couple one end of said unified frame member with said base; and
a support member configured to be supported by said unified frame at an opposite end from said base, and to support and retain the personal electronic device.

2. The stand according to claim 1, wherein said frames define a plurality of first openings, and further comprising a plurality of fastener members, and wherein said spacers define openings that extend at least partially axially therethrough, said fastener members extending through said frames and said spacers to cause said spacers to be fixedly positioned between said frames.

3. The stand according to claim 2, wherein said support member is configured to temporarily retain the personal electronic device.

4. The stand according to claim 2, wherein said frames further define the second set of openings along said frames.

5. The stand according to claim 2, wherein said second set of openings include individual openings positioned between two of the first openings.

6. The stand according to claim 5, wherein the second set of openings are geometrically shaped and substantially match one another on each of the frames.

7. The stand according to claim 1, wherein said support member includes:
a support spacer that defines an opening that extends at least partially radially therethrough through a region substantially centrally positioned between said frames, said support spacer further defining a plurality of openings that extend at least partially axially therethrough, and wherein said frames define a plurality of openings at the opposite end from said base that align with the plurality of openings of said support spacer of said support member;
a plurality of fasteners that, when extended through said frames and said support spacer disposed therebetween, prevent said support spacer from rotating relative to said frames; and
a personal electronic device holder adapted to support and retain the personal electronic device to enable a user of the personal electronic device to operate the personal electronic device.

8. The stand according to claim 1, further comprising a power cord extending from said base and being in electrical communication with a power adapter at said support member to enable power to be delivered to the personal electronic device.

9. The stand according to claim 1, wherein the spline causes the unified frame to counter-balance against weight of the personal electronic device and supporting hardware, thereby causing center of gravity of the stand to be positioned substantially over said base when said base is positioned on a floor.

10. The stand according to claim 1, wherein said adapter member is configured to enable the personal electronic device to rotate.

11. A method manufacturing a stand for supporting a personal electronic device, said method comprising:
providing a unified frame having a curved shape between a first end and a second end;
providing a base;
coupling the first end of the unified frame to the base; and
supporting a support member at the second end of the unified frame, the support member adapted to support and retain the personal electronic device.

12. The method according to claim 11, wherein providing a unified frame includes providing a unified frame with a spline shape.

13. The method according to claim 11, wherein the support member is adapted to clamp a personal electronic device that is tablet shaped thereto.

14. The method according to claim 11, further comprising assembling the unified frame by fixedly positioning a plurality of spacers along and between a plurality of frames, the spacers, when positioned between the frames, causing the frames to be substantially parallel with one another.

15. The method according to claim 11, further comprising extending a power cord from the base to the support member to charge a rechargeable battery at the stand.

16. A stand for supporting a personal electronic device, said stand comprising:
a base;
a unified frame having a curved shape between a first end and a second end, the first end of said unified frame being coupled to said base; and
a support member coupled to the second end of said unified frame, and configured to support and retain the personal electronic device.

17. The stand according to claim 16, wherein said unified frame includes:
a plurality of frames; and
a plurality of spacers being fixedly positioned along and between said plurality of frames.

18. The stand according to claim 17, wherein said plurality of frames are substantially identical and each define two sets of a plurality of openings, a first set of openings configured to enable fastening members to be retained between said frames, and a second set of openings being positioned along said frames.

19. The stand according to claim 16, wherein said unified frame has a spline shape.

20. The stand according to claim 18, wherein the spline shape causes the center of gravity to be positioned over said base when (i) the personal electronic device is being supported and retained and (ii) said base is positioned on a floor.

21. The stand according to claim 16, further comprising:
a rechargeable battery, said base being configured to store said rechargeable battery;
a power cord extending from said base, and in electrical communication with said rechargeable battery; and
a power adapter in electrical communication with said rechargeable battery, and configured to enable a user to power the personal electronic device.
